(19) United States
(12) Patent Application Publication
(10) Pub. No.: US 2009/0245351 A1
(43) Pub. Date: Oct. 1, 2009

(54) MOVING PICTURE DECODING APPARATUS AND MOVING PICTURE DECODING METHOD

(75) Inventor: Kiwamu Watanabe, Kanagawa (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/404,514

(22) Filed: Mar. 16, 2009

(30) Foreign Application Priority Data
Mar. 28, 2008 (JP) 2008-087325
Mar. 28, 2008 (JP) 2008-112594

(51) Int. Cl. H04N 7/26

(52) U.S. Cl. 375/240.03; 375/240.16; 375/E07.123; 375/E07.14

(57) ABSTRACT

A motion vector decoding section alternately decodes motion vectors of sub-reference blocks that respectively belong to two reference blocks in different reference directions. Upon decoding of each set of motion vectors of the sub-reference blocks in the two reference blocks, a block boundary strength calculating section calculates a block boundary strength bS of a sub-macroblock currently being processed and corresponding to the position of the sub-reference blocks.

### CROSS-REFERENCE TO RELATED APPLICATIONS

This application is based upon and claims the benefit of priority from the prior Japanese Patent Applications No. 2008-112594, filed on Mar. 28, 2008, the entire contents of both of which are incorporated herein by reference.

### BACKGROUND OF THE INVENTION

1. Field of the Invention

The present invention relates to a moving picture decoding apparatus and a moving picture decoding method. In particular, the present invention is preferably applied to deblocking filtering in moving picture decoding.

2. Description of the Related Art

As a next generation technology for moving picture compression coding, H.264-1dvanced video coding (AVC) standard has attracted attention. Using motion compensation with quarter pixel accuracy, intra-frame prediction, discrete cosine transform (DCT) using integer accuracy of 4×4 pixel unit, for example, H.264-1VC standard achieves compression coding with higher efficiency than other compression coding techniques such as moving picture experts group 2 (MPEG2).

In MPEG-2, the macroblock size for motion compensation is fixed to 16×16 pixels. In H.264-1VC, seven macroblock sizes are prepared including not only 16×16 pixels, but also 16×8 pixels, 8×16 pixels, 8×8 pixels, 8×4 pixels, 4×8 pixels, and 4×4 pixels. This enables a selection arbitrary from these macroblock sizes, thus realizing more accurate motion compensation.

In an image compression coding system that processes block units, noise easily occurs around the boundary of blocks (block noise). Particularly, in inter prediction using an image compression coding system such as MPEG2, when a decoded image including block noise is referred for motion compensation, image deterioration may be propagated across frames. In H.264-1VC standard, however, a deblocking filter for preventing such block noise is introduced, so that adjustment is made between neighboring blocks.

The deblocking filter is built in a code loop as an in-loop filter, so that a prediction image is created by adaptively-weighting a decoded image. By using such deblocking filter, H.264-1VC standard removes block noise from a prediction error in motion compensation, thereby improving coding efficiency.

For example, Japanese Patent Application Laid-open No. 2007-208476 discloses a method including: setting a judgement threshold for judging whether to perform deblocking filtering depending on a load level indicating the level of the magnitude of a processing load in a moving picture decoding apparatus; and controlling not to perform the deblocking filtering if a processing parameter, obtained from neighboring blocks among a plurality of blocks constituting each frame, is less than the judgement threshold.

In conventional moving picture decoding apparatuses, vectors are decoded in the order in which sub-macroblocks appear in an input bit stream. For example, assuming a macroblock size for motion compensation is 4×4 pixels, when motion compensation is started with two frames in L0/L1 directions, decoding is first performed on motion vectors of all 16 sub-macroblocks within one macroblock in the L0 direction, and then performed on motion vectors of all 16 sub-macroblocks within one macroblock in the L1 direction.

After decoding of all the 16 sub-macroblocks in each of the L0/L1 directions, the deblocking filter refers to motion vector information of their neighboring blocks in each of the L0/L1 directions so as to calculate a block boundary strength bS.

Calculation of the block boundary strength bS requires motion vector information of neighboring blocks of all the 16 sub-macroblocks in each of the L0/L1 directions. This requires the motion vector information of the neighboring blocks to be re-read from a temporary memory, thus posing a problem of wasting extra cycles and electric power.

Specifically, assume that motion vector information of one 4×4 pixel sub-macroblock is 31 bits. Calculation of the block boundary strength bS of one 4×4 pixel sub-macroblock requires motion vector information of three neighboring sub-macroblocks around a sub-macroblock currently being processed, in each of the L0/L1 directions. This requires data of 6×31=186 bits to be read out from a temporary memory. Thus, for the entire one 16×16 pixel macroblock, data of 16×186=2976 bits needs to be read out from a temporary memory.

When motion vector information of sub-macroblocks within the same macroblock is stored in a register and the motion vector information is reused for sub-macroblocks within the same macroblock, the motion vector information of such sub-macroblocks within the same macroblock need not be re-read from the temporary memory. Even in this case, however, a register is necessary for data of 1550 bits including: motion vector information of a sub-macroblock currently being processed; and motion vector information of neighboring blocks around the sub-macroblock. This poses a problems of increasing the circuit size.

### BRIEF SUMMARY OF THE INVENTION

A moving picture decoding apparatus according to an embodiment of the present invention comprises: a motion vector decoding section that alternately decodes motion vectors of two sub-reference blocks that show prediction images of a sub-macroblock, and that belong to reference blocks showing prediction images created in two reference directions used to create a prediction image of a macroblock; and a block boundary strength calculating section that calculates a block boundary strength at a position corresponding to the sub-macroblocks upon decoding each set of the motion vectors of the sub-reference blocks on the two reference blocks.

A moving picture decoding method according to an embodiment of the present invention comprises: decoding a motion vector of a first sub-reference block belonging to a first reference block; decoding a motion vector of a second sub-reference block belonging to a second reference block in a reference direction different from a reference direction of the first reference block; calculating a block boundary strength of a first sub-macroblock that corresponds to a position of the first and the second sub-reference blocks, after decoding of the motion vectors of the first and the second sub-reference blocks; decoding a motion vector of a third sub-reference block belonging to the first reference block, after calculation of the block boundary strength of the first sub-macroblock; decoding a motion vector of a fourth sub-reference block belonging to the second reference block, after calculation of the block boundary strength of the first sub-macroblock; and calculating a block boundary strength of a second sub-macroblock that corresponds to a position of the third and the fourth sub-reference blocks, after decoding of the motion vectors of the third and the fourth sub-reference blocks.

A moving picture decoding method according to an embodiment of the present invention comprises: decoding a motion vector of a first sub-reference block belonging to a first reference block; decoding a motion vector of a second sub-reference block belonging to the first reference block and neighboring the first sub-reference block; decoding a motion vector of a third sub-reference block belonging to a second reference block in a reference direction different from a reference direction of the first reference block;

decoding a motion vector of a fourth sub-reference block belonging to the second reference block and neighboring the third sub-reference block; calculating a block boundary strength of a first sub-macroblock corresponding to a position of the first and the third sub-reference blocks, after decoding of the motion vectors of the first to the fourth sub-reference blocks; and calculating a block boundary strength of a second sub-macroblock corresponding to a position of the second and the fourth sub-reference blocks, after decoding of the motion vectors of the first to the fourth sub-reference blocks.

### BRIEF DESCRIPTION OF THE DRAWINGS

FIG. 1 is a schematic block diagram of a moving picture decoding apparatus according to a first embodiment of the present invention;

FIG. 2 depicts how a motion vector decoding section 12 shown in FIG. 1 predicts motion vectors;

FIG. 3 depicts pixels whose boundary strength is calculated by a block boundary strength calculating section 13 shown in FIG. 1;

FIG. 4-1 depicts the order in which sub-macroblocks appear in an input bit stream according to an embodiment of the present invention;

FIG. 4-2 depicts the order in which sub-macroblocks are decoded to calculate a boundary strength according to an embodiment of the present invention;

FIG. 5 depicts the order of decoding motion vectors and calculating a boundary strength according to an embodiment of the present invention;

FIG. 6 is a block diagram depicting connection of a register used to calculate a block boundary strength according to a second embodiment of the present invention;

FIG. 7 depicts another example of the order in which sub-macroblocks are decoded to calculate a boundary strength; and

FIG. 8 depicts conditions for setting a block boundary strength bS.

### DETAILED DESCRIPTION OF THE INVENTION

Exemplary embodiments of a moving picture decoding apparatus according to the present invention are described with reference to the accompanying drawings. The present invention is not limited to the following embodiments.

### First Embodiment

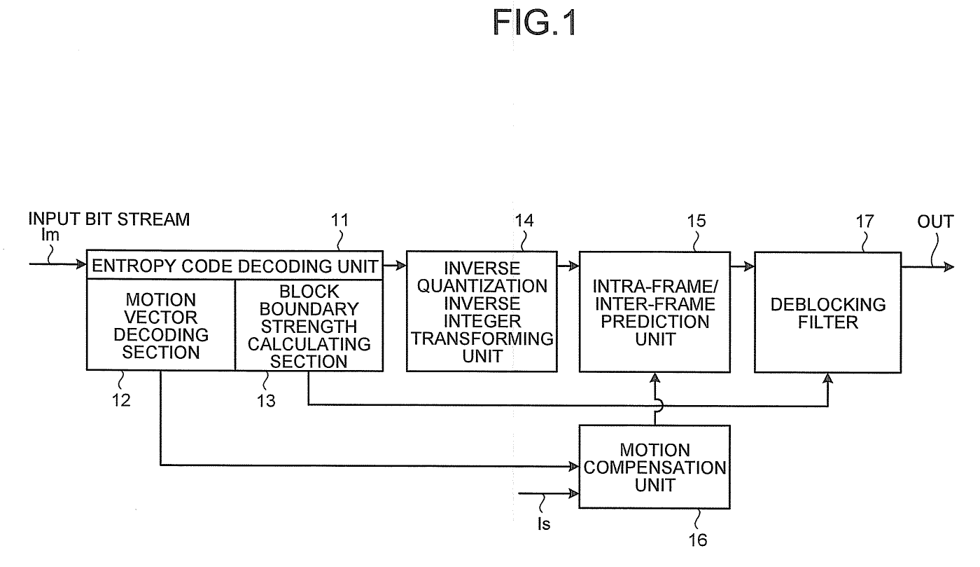

FIG. 1 is a schematic block diagram of a moving picture decoding apparatus according to a first embodiment of the present invention. In the description of the present application, a macroblock refers to a 16×16 pixel block as a divided segment of a frame, and a sub-macroblock refers to a 4×4 pixel block as a divided segment of such macroblock. Further, a reference block refers to a 16×16 pixel block that is referred to create a prediction image of a macroblock, and a sub-reference block refers to a 4×4 pixel block as a divided segment of such reference block.

In FIG. 1, the moving picture decoding apparatus includes an entropy code decoding unit 11 that decodes an entropy code contained in an input bit stream Im, an inverse quantization inverse integer transforming unit 14 that inversely quantizes a quantized orthogonal transform coefficient, and transforms the inversely quantized orthogonal transform coefficient to an inverse integer, an intra-frame/inter-frame prediction unit 15 that creates a decoded image based on intra-frame prediction and inter-frame prediction; a motion compensation unit 16 that creates an inter-frame prediction image from a reference frame Is, based on a motion vector of a block to be decoded, and a deblocking filter 17 that adaptively weights a decoded image based on whether block boundary noise easily occurs.

The input bit stream Im may include coded moving picture data, motion vector information used in inter-frame prediction coding for motion compensation (inter prediction coding), and intra-frame prediction information used in intra-frame prediction coding (intra prediction coding).

The inter-frame prediction coding for motion compensation uses images located at a position shifted by an amount of motion on respective reference frames in different reference directions. In this way, an inter-frame prediction image is created, and coding is performed on an inter-frame error image that corresponds to a difference between the inter-frame prediction image and an input image. On the other hand, in the intra-frame prediction coding, an intra-frame prediction image is created by interpolation using neighboring pixels of neighboring macroblocks located immediately above and to the left of a macroblock not using the inter-frame prediction. Then, coding is performed on an intra-frame error image that corresponds to a difference between the intra-frame prediction image and an input image.

According to H.264-1VC standard, discrete cosine transform (DCT) and discrete hadamard transform (DHT) with integer accuracy of 4×4 -1nd 8×8 are used for orthogonal transform. DCT and DHT are used depending on intra and inter prediction methods and the content of signals, such as brightness and chroma difference.

As the reference frame Is for motion compensation, a plurality of frames may be used that have undergone the deblocking filtering. As to B frame for example, without using frames in future directions, two previous frames may be assigned as reference frames. Alternatively, another B frame may be assigned as a reference frame.

The deblocking filter 17 can process a portion including a discontinuity that breaks continuity across a boundary between neighboring sub-macroblocks within a macroblock, thereby removing such discontinuity and smoothing the portion. Further, the deblocking filter 17 can use the block boundary strength bS as an index for determining whether block boundary noise easily occurs. By changing the filter strength depending on the value of the block boundary strength bS, the deblocking filter 17 can perform filtering suitable for each block boundary.

The entropy code decoding unit 11 includes a motion vector decoding section 12 and a block boundary strength calculating section 13. The motion vector decoding section 12 can alternately decode motion vectors of sub-reference blocks that respectively belong to two reference blocks in different reference directions. Upon decoding each set of motion vectors of the sub-reference blocks on the two reference blocks, the block boundary strength calculating section 13 can calculate the block boundary strength bS of a sub-macroblock currently being processed and corresponding to the position of the sub-reference blocks.

When the input bit stream Im is input to the entropy code decoding unit 11, an entropy decoding process is performed in the entropy code decoding unit 11. Accordingly, quantized orthogonal transform coefficient, motion vector information, intra-frame prediction information, and the like are extracted from the input bit stream Im. The orthogonal transform coefficient, the intra-frame prediction information, and the like extracted in the entropy code decoding unit 11 are then output to the inverse quantization inverse integer transforming unit 14, while the motion vector information is output to the motion vector decoding section 12.

Upon receiving the orthogonal transform coefficient extracted in the entropy code decoding unit 11, the inverse quantization inverse integer transforming unit 14 inversely quantizes the orthogonal transform coefficient, and transforms the inversely quantized orthogonal transform coefficient to an inverse integer. In this way, the inverse quantization inverse integer transforming unit 14 creates an intra-frame error image and an inter-frame error image, and outputs the created error images to the intra-frame/inter-frame prediction unit 15.

On the other hand, upon receiving the motion vector information, the motion vector decoding section 12 alternately decodes motion vector information of sub-reference blocks that respectively belong to two reference blocks in different reference directions. The motion vector decoding section 12 then outputs the decoded information to the block boundary strength calculating section 13 and the motion compensation unit 16.

Upon receiving the motion vector information of the two sub-reference blocks in the different prediction directions, the motion compensation unit 16 performs motion compensation on the reference frame Is based on the received motion vector information. In this way, the motion compensation unit 16 creates an inter-frame prediction image, and outputs the created prediction image to the intra-frame/inter-frame prediction unit 15.

The intra-frame/inter-frame prediction unit 15 decodes an inter frame by adding a pixel value of the inter-frame prediction image to a pixel value of the inter-frame error image received from the inverse quantization inverse integer transforming unit 14-1nd outputs the decoded information to the deblocking filter 17. The intra-frame/inter-frame prediction unit 15 also creates an intra-frame prediction image using a pixel value of a decoded block neighboring the block to be decoded. The intra-frame/inter-frame prediction unit 15 then decodes an intra frame by adding a pixel value of the intra-frame prediction image to a pixel value of the intra-frame error image received from the inverse quantization inverse integer transforming unit 14-1nd outputs the decoded information to the deblocking filter 17.

Upon receiving the motion vector information of the two sub-reference blocks in the different reference directions, the block boundary strength calculating section 13 calculates a block boundary strength bS of the current sub-macroblock, based on the motion vector information of the current sub-reference block and on the motion vector information of decoded neighboring sub-macroblocks around the current sub-macroblock. Then, the block boundary strength calculating section 13 outputs the calculated block boundary strength bS to the deblocking filter 17. Alternatively, upon decoding of the motion vector information of the current two sub-reference blocks in the different reference directions, the block boundary strength calculating section 13 can calculate a block boundary strength bS of the current sub-macroblock before decoding of motion vector information of the next two sub-reference blocks in different reference directions.

The deblocking filter 17 changes the filter strength depending on the value of the block boundary strength bS, and thereby performs filtering suitable for each block boundary on each frame decoded by the intra-frame/inter-frame prediction unit 15. In this way, the deblocking filter 17 creates an output image OUT.

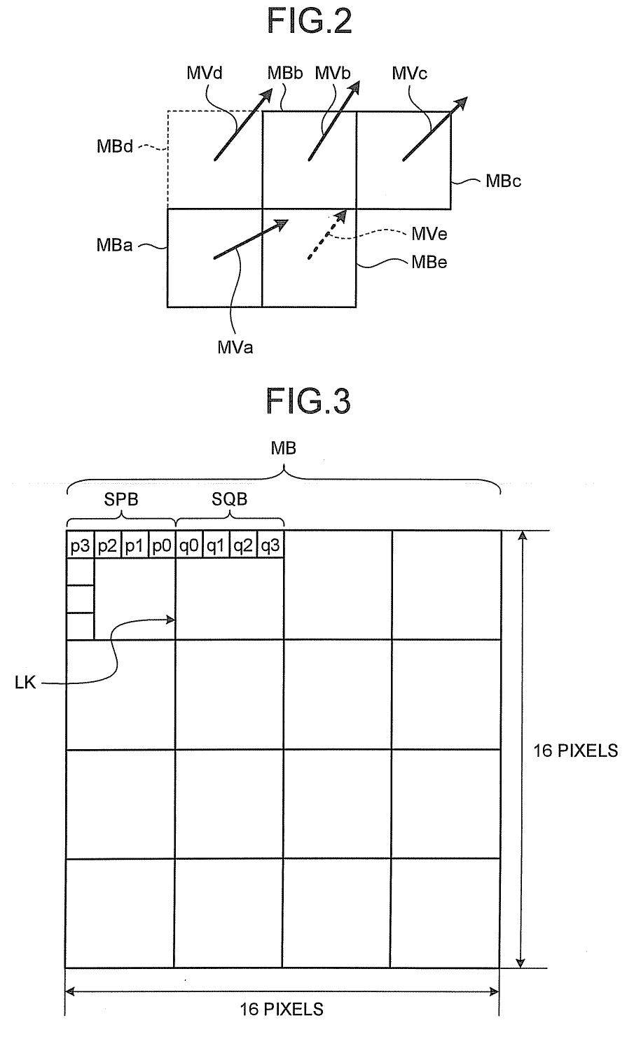

FIG. 2 depicts how the motion vector decoding section 12 shown in FIG. 1 predicts motion vectors.

In FIG. 2, indicated by MBe is a sub-macroblock whose motion vector is currently to be decoded. On the immediate left of, immediately above, and on the immediate top right of the sub-macroblock MBe are located a sub-macroblock MBa, a sub-macroblock MBb, and a sub-macroblock MBc, respectively.

In H.264-1VC standard, a motion vector MVe of the sub-macroblock MBe is given by Equation (1):

MVe=mve+Median(mvA, mvB, mvC) (1)

where mve is a difference value from a motion vector of a neighboring block appearing in the input bit stream Im, mvA is a value of a motion vector MVa of the sub-macroblock MBa, mvB is a value of a motion vector MVb of the sub-macroblock MBb, mvC is a value of a motion vector MVc of the sub-macroblock MBc, and Median is an intermediate value of the values of the motion vectors MVa, MVb, and MVc.

In decoding the motion vector MVe of the sub-macroblock MBe, if the motion vector MVc of the sub-macroblock MBc has not been decoded, a motion vector MVd of a sub-macroblock MBd located immediately to the top left of the sub-macroblock MBe can be used instead of the motion vector MVc of the sub-macroblock MBc.

FIG. 3 depicts pixels whose boundary strength is calculated by the block boundary strength calculating section 13 shown in FIG. 1.

In FIG. 3, assume that a 16×16 pixel macroblock MB is divided into 4×4 pixel sub-macroblocks and that a block boundary strength bS is found for a boundary LK between sub-macroblocks SPB and SQB. In this case, the block boundary strength bS is set depending on whether pixels p0 to p3 of the sub-macroblock SPB and pixels q0 to q3 of the sub-macroblock SQB meet any condition shown in FIG. 8.

As shown in FIG. 8, to determine whether the block boundary strength bS is 1 or 0, neighbor information such as motion vector MV used for motion compensation is referred. Further, motion vector information of a sub-macroblock currently being decoded and motion vector information of neighboring sub-macroblocks are necessary.

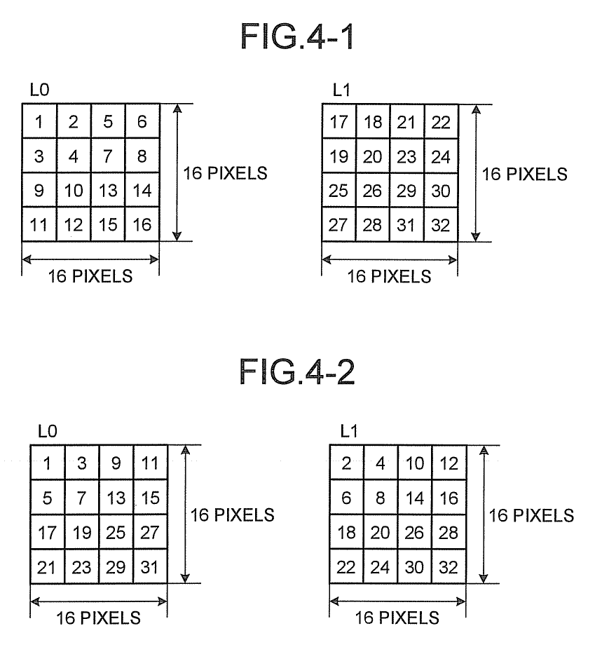

FIG. 4-1 depicts the order in which sub-macroblocks appear in an input bit stream according to an embodiment of the present invention. FIG. 4-2 depicts the order in which sub-macroblocks are decoded to calculate a boundary strength according to an embodiment of the present invention.

In FIG. 4-1, provided that the position of a sub-macroblock within a macroblock is specified as i row and j column (i=1, 2, 3, 4, j=1, 2, 3, 4), sub-macroblocks appear in an input bit stream Imd in the following order:
(1, 1)_{L0}→(1, 2)_{L0}→(2, 1)_{L0}→(2, 2)_{L0}→(1, 3)_{L0}→(1, 4)_{L0}→(2, 3)_{L0}→(2, 4)_{L0}→(3, 1)_{L0}→(3, 2)_{L0}→(4, 1)_{L0}→(4, 2)_{L0}→(3, 3)_{L0}→(3, 4)_{L0}→(4, 3)_{L0}→(4, 4)_{L0}→(1, 1)_{L1}→(1, 2)_{L1}→(2, 1)_{L1}→(2, 2)_{L1}→(1, 3)_{L1}→(1, 4)_{L1}→(2, 3)_{L1}→(2, 4)_{L1}→(3, 1)_{L1}→(3, 2)_{L1}→(4, 1)_{L1}→(4, 2)_{L1}→(3, 3)_{L1}→(3, 4)_{L1}→(4, 3)_{L1}→(4, 4)_{L1}, where (i,j)_{L0} is the position of a sub-reference block in a reference block included in a reference frame in the L0 direction, and (i,j)_{L1} is the position of a sub-reference block in a reference block included in a reference frame in the L1 direction.

On the contrary, the motion vectors of sub-macroblocks in the LO/L1 directions are decoded in the order shown in FIG. 4-2.

Specifically, as shown in FIG. 4-2, motion vectors of sub-macroblocks in the L0/L1 directions are decoded in the following order:
(1, 1)_{L0}→(1, 1)_{L1}→(1, 2)_{L0}→(1, 2)_{L1}→(2, 1)_{L0}→(2, 1)_{L1}→(2, 2)L₀→(2, 2)_{L1}→(1, 3)_{L0}→(1, 3)_{L1}→(1, 4)_{L0}→(1, 4)_{L1}→(2, 3)_{L0}→(2, 3)_{L1}→(2, 4)_{L0}→(2, 4)_{L1}→(3, 1)_{L0}→(3, 1)_{L1}→(3, 2)_{L0}→(3, 2)_{L1}→(4, 1)_{L0}→(4, 1)_{L1}→(4, 2)_{L0}→(4, 2)_{L1}→(3, 3)_{L0}→(3, 3)_{L1}→(3, 4)_{L0}→(3, 4)_{L1}→(4, 3)_{L0}→(4, 3)_{L1}→(4, 4)_{L0}→(4, 4)_{L1}.

Further, calculation of the block boundary strength bS of the current sub-macroblock is performed after decoding of each set of motion vectors of the current sub-macroblocks in the L0/L1 directions and before decoding each set of motion vectors of the next two sub-macroblocks in the L0/L1 directions.

Specifically, decoding of the motion vectors of the sub-macroblocks in the L0/L1 directions and calculation of the block boundary strength bS of the current sub-macroblock is performed in the following order:
(1, 1)_{L0}→(1, 1)_{L1}→(1, 1)_{bS}→(1, 2)_{L0}→(1, 2)_{L1}→(1, 2)_{bS}→(2, 1)_{L0}→(2, 1)_{L1}→(2, 1)_{bS}→(2, 2)_{L0}→(2, 2)_{L1}→(2, 2)_{bS}→(1, 3)_{L0}→(1, 3)_{L1}→(1, 3)_{bS}→(1, 4)_{L0}→(1, 4)_{L1}→(1, 4)_{bS}→(2, 3)_{L0}→(2, 3)_{L1}→(2, 3)_{bS}→(2, 4)_{L0}→(2, 4)_{L1}→(2, 4)_{bS}→(3, 1)_{L0}→(3, 1)_{L1}→(3, 1)_{bS}→(3, 2)_{L0}→(3, 2)_{L1}→(3, 2)_{bS}→(4, 1)_{L0}→(4, 1)_{L1}→(4, 1)_{bS}→(4, 2)_{L0}→(4, 2)_{L1}→(4, 2)_{bS}→(3, 3)_{L0}→(3, 3)_{L1}→(3, 3)_{bS}→(3, 4)_{L0}→(3, 4)_{L1}→(3, 4)_{bS}→(4, 3)_{L0}→(4, 3)_{L1}→(4, 3)_{bS}→(4, 4)_{L0}→(4, 4)_{L1}→(4, 4)_{bS.}

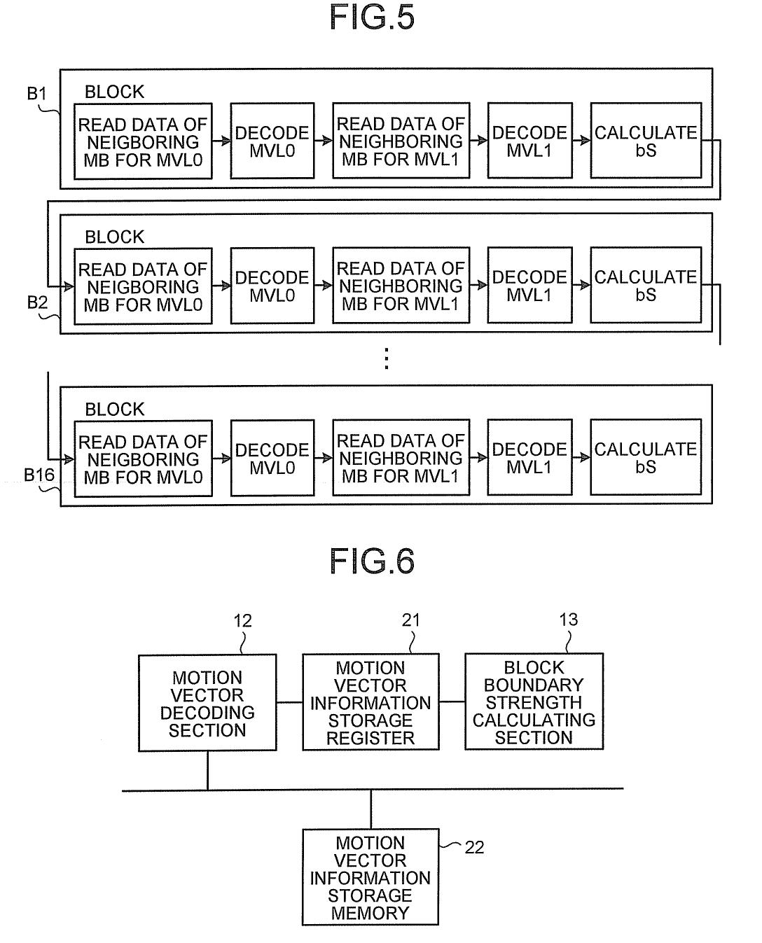

FIG. 5 depicts the order of decoding motion vectors and calculating a boundary strength according to an embodiment of the present invention.

In FIG. 5, assume that B1 is a sub-macroblock at a position (1, 1), B2 is a sub-macroblock at a position (1, 2), B3 is a sub-macroblock at a position of (2, 1), B4 is a sub-macroblock at a position of (2, 2), B5 is a sub-macroblock at a position of (1, 3), B6 is a sub-macroblock at a position of (1, 3), B7 is a sub-macroblock at a position of (2, 3), B8 is a sub-macroblock at a position of (2, 4), B9 is a sub-macroblock at a position of (3, 1), B10 is a sub-macroblock at a position of (3, 2), B11 is a sub-macroblock at a position of (4, 1), B12 is a sub-macroblock at a position of (4, 2), B13 is a sub-macroblock at a position of (3, 3), B14 is a sub-macroblock at a position of (3, 3), B15 is a sub-macroblock at a position of (4, 3), and B16 is a sub-macroblock at a position of (4, 4). In this case, decoding of motion vectors of sub-reference blocks in the L0/L1 directions, and calculation of the block boundary strength bS of the current sub-macroblock can be performed in the order of B1→B2→, . . . →B16.

Data of a neighboring sub-macroblok around each of the sub-macroblocks B1 to B16, which is used to calculate a motion vector of a corresponding sub-reference block in the L0 direction, is read out, and then the motion vector of the sub-reference block in the L0 direction is decoded. Further, data of a neighboring sub-macroblock around each of the sub-macroblocks B1 to B16, which is used to calculate a motion vector of a corresponding sub-reference block in the L1 direction, is read out, and then the motion vector of the sub-reference block in the L1 direction is decoded. Then, the block boundary strength bS is calculated for the current sub-macroblock, and this calculation is done for each of the sub-macroblocks B1 to B16.

With this arrangement, before decoding of the motion vectors of all the 16 sub-macroblocks B1 to B16 in each of the L0/L1 directions, the block boundary strength bS of the current sub-macroblock is calculated upon decoding of each set of motion vectors of the sub-macroblocks B1 to B16 in the L0/L1 directions. Further, motion vector information of neighboring sub-macroblocks, which is used to decode motion vectors of the sub-macroblocks B1 to B16 in the L0/L1 directions, is stored in a register, so that the block boundary strength bS can be calculated for each of the sub-macroblocks B1 to B16. This eliminates the need to re-read the motion vector information of all the 16 sub-macroblocks B1 to B16 in the L0/L1 directions from a temporal memory. Thus, the number of cycles for calculating the block boundary strength bS is reduced, while the increase in circuit size is prevented.

### Second Embodiment

FIG. 6 is a block diagram depicting connection of a register used to calculate a block boundary strength according to a second embodiment of the present invention.

As shown in FIG. 6, a moving picture decoding apparatus includes a motion vector information storage register 21 and a motion vector information storage memory 22. Data is read out from the motion vector information storage memory 22 by designating an address, whereas data can be read out from the motion vector information storage register 21 without designating an address. Although the motion vector information storage register 21 has a smaller capacity than the motion vector information storage memory 22, the motion vector information storage register 21 can read data at high speed. As the motion vector information storage memory 22, a static random access memory (SRAM) may be used, for example. The motion vector information storage memory 22 is connected to the motion vector decoding section 12, and the motion vector information storage register 21 is connected to the motion vector decoding section 12 and the block boundary strength calculating section 13.

The motion vector information storage register 21 can store therein motion vector information of neighboring sub-macroblocks oriented in each of the L0/L1 directions and neighboring a sub-macroblock whose motion vector is currently being decoded. Assuming that the motion vector information of the sub-macroblocks B1 to B16 each corresponding to one set of 4×4 pixels is 31 bits, the motion vector information storage register 21 may only require a size of 6×31=186 bits. This is because, in each of the L0/L1 directions, motion vector information of three neighboring sub-macroblocks is necessary to calculate the block boundary strength bS of each of the sub-macroblocks B1 to B16. The motion vector information storage memory 22 can store therein motion vector information of the 16 sub-macroblocks B1 to B16 in each of the L0/L1 directions, which is used to decode motion vectors of the sub-macroblocks B1 to B16.

The motion vector decoding section 12 sequentially reads out from the motion vector information storage memory 22 the motion vector information of the neighboring sub-macroblocks, which is used to decode the motion vectors of the sub-macroblocks B1 to B16 in each of the L0/L1 directions. Upon reading the motion vector information of each of the sub-macroblocks B1 to B16 from the motion vector information storage memory 22, decoding is performed on the motion vector information of the sub-macroblocks in the L0/L1 directions. Further, the motion vector information currently read out from the motion vector information storage memory 22 is stored in the motion vector information storage register 21.

As shown in Equation (1), to decode the motion vector MVe of the current sub-macroblock MBe, the values of three motion vectors MVa, MVb, and MVc are used as motion vector information of neighboring sub-macroblocks. Because the values of the three motion vectors MVa, MVb, and MVc are necessary to decode the motion vector information of each of the sub-macroblocks B1 to B16 in each of the L0/L1 directions, six motion vector values are necessary as motion vector information of neighboring sub-macroblocks.

Every time the motion vector decoding section 12 decodes the motion vector information of each of the sub-macroblocks B1 to B16 in the L0/L1 directions, the block boundary strength calculating section 13 sequentially reads out from the motion vector information storage register 21 the motion vector information of neighboring sub-macroblocks, which is used to calculate the block boundary strength bS of the current sub-macroblock of the sub-macroblocks B1 to B16.

Based on the motion vector information of the current sub-macroblocks B1 to B16 and the motion vector information of the decoded neighboring sub-macroblocks B1 to B16 around the current sub-macroblocks B1 to B16, the block boundary strength calculating section 13 sequentially calculates the block boundary strength bS of each of the current sub-macroblocks B1 to B16, and outputs the calculated block boundary strength bS to the deblocking filter 17 shown in FIG. 1.

The motion vector information of the neighboring sub-macroblocks B1 to B16, which is used to calculate the block boundary strength bS of the sub-macroblocks B1 to B16, is common to the motion vector information of the neighboring sub-macroblocks B1 to B16 in the L0/L1 directions, which is used to perform motion compensation on the sub-macroblocks B1 to B16. Thus, the motion vector information of the neighboring sub-macroblocks B1 to B16, which has been stored in the motion vector information storage register 21, can be commonly used to calculate the block boundary strength bS.

As such, the motion vector information of the neighboring sub-macroblocks B1 to B16 around the current sub-macroblocks B1 to B16 is stored in the motion vector information storage register 21, so that the motion vector information of the sub-macroblocks B1 to B16 can be reused to decode the motion vector information and to calculate the block boundary strength bS. This eliminates the need to re-read from the motion vector information storage memory 22 the motion vector information of the neighboring sub-macroblocks B1 to B16 to calculate the block boundary strength bS. Thus, the number of cycles of calculating the block boundary strength bS is reduced, while the increase in circuit size is prevented.

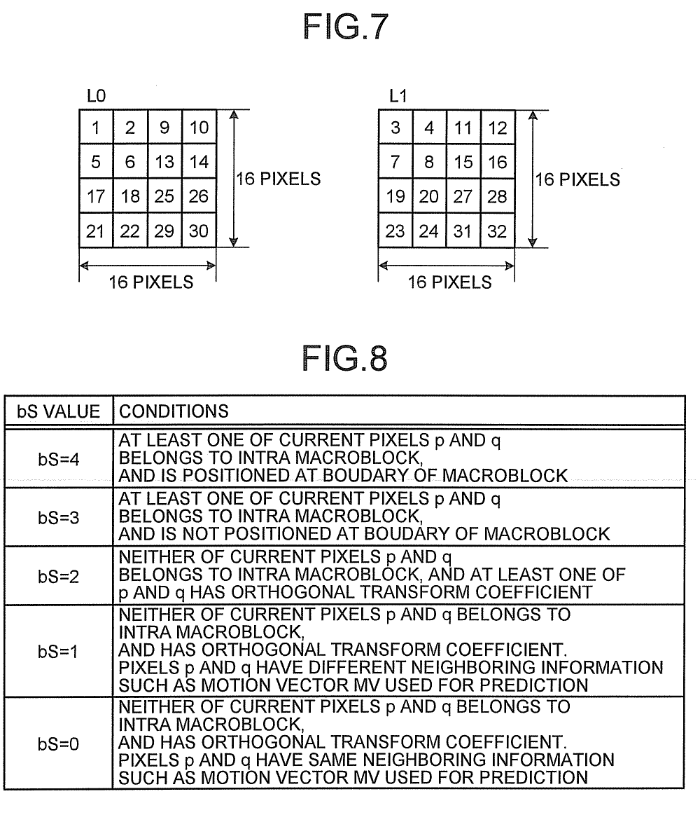

FIG. 4-2 depicts one example of the order of decoding sub-macroblocks to calculate the boundary strength. The decoding order is not limited to this, and may be the order shown in FIG. 7, for example.

As shown in FIG. 7, the motion vectors of sub-reference blocks in the L0/L1 directions may be decoded in the following order:
(1, 1)_{L0}→(1, 2)_{L0}→(1, 1)_{L1}→(1, 2)_{L1}→(2, 1)_{L0}→(2, 2)_{L0}→(2, 1)_{L1}→(2, 2)_{L1}→(1, 3)_{L0}→(1, 4)_{L0}→(1, 3)_{L1}→(1, 4)_{L1}→(2, 3)_{L0}→(2, 4)_{L0}→(2, 3)_{L1}→(2, 4)_{L1}→(3, 1)_{L0}→(3, 2)_{L0}→(3, 1)_{L1}→(3, 2)_{L1}→(4, 1)_{L0}→(4, 2)_{L0}→(4, 1)_{L1}→(4, 2)_{L1}→(3, 3)_{L0}→(3, 4)_{L0}→(3, 3)_{L1}→(3, 4)_{L1}→(4, 3)_{L0}→(4, 4)_{L0}→(4, 3)_{L1}→(4, 4)_{L1}.

Further, the decoding of the motion vectors of sub-reference blocks in the L0/L1 directions and the calculation of the block boundary strength bS of the current sub-macroblock may be performed in the following order:
(1, 1)_{L0}→(1, 2)_{L0}→(1, 1)_{L1}→(1, 2)_{L1}→(1, 1)_{bS}→(1, 2)_{bS}→(2, 1)_{L0}→(2, 2)_{L0}→(2, 1)_{L1}→(2, 2)_{L1}→(2, 1)_{bS}→(2, 2)_{bS}→(1, 3)_{L0}→(1, 4)_{L0}→(1, 3)_{L1}→(1, 4)_{L1}→(1, 3)_{bS}→(1, 4)_{bS}→(2, 3)_{L0}→(2, 4)_{L0}→(2, 3)_{L1}→(2, 4)_{L1}→(2, 3)_{bS}→(2, 4)_{bS}→(3, 1)_{L0}→(3, 2)_{L0}→(3, 1)_{L1}→(3, 2)_{L1}→(3, 1)_{bS}→(3, 2)_{bS}→(4, 1)_{L0}→(4, 2)_{L0}→(4, 1)_{L1}→→(4, 2)_{L1}→(4, 1)_{bS}→(4, 2)_{bS}→(3, 3)_{L0}→(3, 4)_{L0}→(3, 3)_{L1}→(3, 4)_{L1}→(3, 3)_{bS}→(3, 4)_{bS}→(4, 3)_{L0}→(4, 4)_{L0}→(4, 3)_{L1}→(4, 4)_{L1}→(4, 3)_{bS}→(4, 4)_{bS}.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A moving picture decoding apparatus, comprising:
a motion vector decoding section that alternately decodes motion vectors of two sub-reference blocks that show prediction images of a sub-macroblock, and that belong to reference blocks showing prediction images created in two reference directions used to create a prediction image of a macroblock; and
a block boundary strength calculating section that calculates a block boundary strength at a position corresponding to the sub-macroblocks upon decoding each set of the motion vectors of the sub-reference blocks on the two reference blocks.

2. The moving picture decoding apparatus according to claim 1, wherein the block boundary strength calculating section calculates, upon decoding of motion vector information of current two sub-reference blocks in different reference directions, a block boundary strength of a current sub-macroblock before decoding of motion vector information of next two sub-reference blocks in different reference directions.

3. The moving picture decoding apparatus according to claim 1, further comprising:
an entropy code decoding unit that decodes an entropy code contained in an input bit stream;
an inverse quantization inverse integer transforming unit that inversely quantizes a quantized orthogonal transform coefficient, and transforms an inversely quantized orthogonal transform coefficient to an inverse integer;
a motion compensation unit that performs motion compensation based on motion vectors of sub-reference blocks decoded in the motion vector decoding section;
an intra-frame/inter-frame prediction unit that creates a decoded image based on intra-frame prediction and inter-frame prediction; and
a deblocking filter that adaptively weights the decoded image based on the block boundary strength calculated by the block boundary strength calculating section.

4. The moving picture decoding apparatus according to claim 3, wherein the deblocking filter changes a filter strength depending on a value of the block boundary strength calculated by the block boundary strength calculating section, and performs filtering suitable for each block boundary on a frame decoded by the intra-frame/inter-frame prediction unit.

5. The moving picture decoding apparatus according to claim 1, further comprising a motion vector information storage register that stores therein motion vector information of neighboring sub-macroblocks around a sub-macroblock currently being processed, wherein
motion vector information of the neighboring sub-macroblocks is written to the motion vector information storage register upon decoding of each set of motion vectors of sub-reference blocks currently being processed on the two reference blocks, and is read out from the motion vector information storage register to calculate the block boundary strength.

6. The moving picture decoding apparatus according to claim 5, wherein the block boundary strength calculating section commonly uses the motion vector information of the neighboring sub-macroblocks, stored in the motion vector information storage register, for calculating the block boundary strength.

7. The moving picture decoding apparatus according to claim 6, wherein the motion vector information storage register stores therein motion vector information of sub-macroblocks respectively located immediately to the left of, immediately above, and immediately to the top right of a sub-macroblock whose motion vector is currently being decoded, the motion vector information including pieces of motion vector information of such three neighboring sub-macroblocks in each of two reference directions used to create the prediction image of the macroblock.

8. The moving picture decoding apparatus according to claim 7, wherein, in decoding a motion vector of a current sub-macroblock, when motion vector information of a sub-macroblock located immediately to the top right thereof has not been decoded, motion vector information of a sub-macroblock located immediately to the top left is stored in the motion vector information storage register instead of the motion vector information of the sub-macroblock located immediately to the top right.

9. The moving picture decoding apparatus according to claim 3, wherein, provided that the macroblock is made up of 16×16 pixels and includes 16 sub-macroblocks of 4×4 pixels and that a position of each of the sub-macroblocks in the macroblock is specified as i row and j column (i=1, 2, 3, 4, j=1, 2, 3, 4), decoding of motion vector information and calculation of a block boundary strength are performed in the following order:
(1, 1)_{L0}→(1, 1)_{L1}→(1, 1)_{bS}→(1, 2)_{L0}→(1, 2)_{L1}→(1, 2)_{bS}→(2, 1)_{L0}→(2, 1)_{L1}→(2, 1)_{bS}→(2, 2)_{L0}→(2, 2)_{L1}→(2, 2)_{bS}→(1, 3)_{L0}→(1, 3)_{L1}→(1, 3)_{bS}→(1, 4)_{L0}→(1, 4)_{L1}→(1, 4)_{bS}→(2, 3)_{L0}→(2, 3)_{L1}→(2, 3)_{bS}→(2, 4)_{L0}→(2, 4)_{L1}→(2, 4)_{bS}→(3, 1)_{L0}→(3, 1)_{L1}→(3, 1)_{bS}→(3, 2)_{L0}→(3, 2)_{L1}→(3, 2)_{bS}→(4, 1)_{L0}→(4, 1)_{L1}→(4, 1)_{bS}→(4, 2)_{L0}→(4, 2)_{L1}→(4, 2)_{bS}→(3, 3)_{L0}→(3, 3)_{L1}→(3, 3)_{bS}→(3, 4)_{L0}→(3, 4)_{L1}→(3, 4)_{bS}→(4, 3)_{L0}→(4, 3)_{L1}→(4, 3)_{bS}→(4, 4)_{L0}→(4, 4)_{L1}→(4, 4)_{bS}, where (i,j)_{L0} is a position of a sub-reference block whose motion vector is to be decoded on a first reference block of the macroblock, (i,j)_{L1} is a position of a sub-reference block whose motion vector is to be decoded on a second reference block, and (i,j)_{bS} is a position of a sub-macroblock whose block boundary strength is to be calculated.

10. The moving picture decoding apparatus according to claim 9, wherein sub-macroblocks appear in the input bit stream in the following order:
(1, 1)_{L0}→(1, 2)_{L0}→(2, 1)_{L0}→(2, 2)_{L0}→(1, 3)_{L0}→(1, 4)_{L0}→(2, 3)_{L0}→(2, 4)_{L0}→(3, 1)_{L0}→(3, 2)_{L0}→(4, 1)_{L0}→(4, 2)_{L0}→(3, 3)_{L0}→(3, 4)_{L0}→(4, 3)_{L0}→(4, 4)_{L0}→(1, 1)_{L1}→(1, 2)_{L1}→(2, 1)_{L1}→(2, 2)_{L1}→(1, 3)_{L1}→(1, 4)_{L1}→(2, 3)_{L1}→(2, 4)_{L1}→(3, 1)_{L1}→(3, 2)_{L1}→(4, 1)_{L1}→(4, 2)_{L1}→(3, 3)_{L1}→(3, 4)_{L1}→(4, 3)_{L1}→(4, 4)_{L1}.

11. A moving picture decoding method, comprising:
decoding a motion vector of a first sub-reference block belonging to a first reference block;
decoding a motion vector of a second sub-reference block belonging to a second reference block in a reference direction different from a reference direction of the first reference block;
calculating a block boundary strength of a first sub-macroblock that corresponds to a position of the first and the second sub-reference blocks, after decoding of the motion vectors of the first and the second sub-reference blocks;
decoding a motion vector of a third sub-reference block belonging to the first reference block, after calculation of the block boundary strength of the first sub-macroblock;
decoding a motion vector of a fourth sub-reference block belonging to the second reference block, after calculation of the block boundary strength of the first sub-macroblock; and
calculating a block boundary strength of a second sub-macroblock that corresponds to a position of the third and the fourth sub-reference blocks, after decoding of the motion vectors of the third and the fourth sub-reference blocks.

12. The moving picture decoding method according to claim 11, wherein, provided that the macroblock is made up of 16×16 pixels and includes 16 sub-macroblocks of 4×4 pixels and that a position of each of the sub-macroblocks in the macroblock is specified as i row and j column (i=1, 2, 3, 4, j=1, 2, 3, 4), decoding of motion vector information and calculation of a block boundary strength are performed in the following order:
(1, 1)_{L0}→(1, 1)_{L1}→(1, 1)_{bS}→(1, 2)_{L0}→(1, 2)_{L1}→(1, 2)_{bS}→(2, 1)_{L0}→(2, 1)_{L1}→(2, 1)_{bS}→(2, 2)_{L0}→(2, 2)_{L1}→(2, 2)_{bS}→(1, 3)_{L0}→(1, 3)_{L1}→(1, 3)_{bS}→(1, 4)_{L0}→(1, 4)_{L1}→(1, 4)_{bS}→(2, 3)_{L0}→(2, 3)_{L1}→(2, 3)_{bS}→(2, 4)_{L0}→(2, 4)_{L1}→(2, 4)_{bS}→(3, 1)_{L0}→(3, 1)_{L1}→(3, 1)_{bS}→(3, 2)_{L0}→(3, 2)_{L1}→(3, 2)_{bS}→(4, 1)_{L0}→(4, 1)_{L1}→(4, 1)_{bS}→(4, 2)_{L0}→(4, 2)_{L1}→(4, 2)_{bS}→(3, 3)_{L0}→(3, 3)_{L1}→(3, 3)_{bS}→(3, 4)_{L0}→(3, 4)_{L1}→(3, 4)_{bS}→(4, 3)_{L0}→(4, 3)_{L1}→(4, 3)_{bS}→(4, 4)_{L0}→(4, 4)_{L1}→(4, 4)_{bS, where (i,j)}_{L0} is a position of a sub-reference block whose motion vector is to be decoded on a first reference block of the macroblock, (i,j)_{L1} is a position of a sub-reference block whose motion vector is to be decoded on a second reference block, and (i,j)_{bS} is a position of a sub-macroblock whose block boundary strength is to be calculated.

13. The moving picture decoding method according to claim 12, wherein sub-macroblocks appear in the input bit stream in the following order:
(1, 1)_{L0}→(1, 2)_{L0}→(2, 1)_{L0}→(2, 2)_{L0}→(1, 3)_{L0}→(1, 4)_{L0}→(2, 3)_{L0}→(2, 4)_{L0}→(3, 1)_{L0}→(3, 2)_{L0}→(4, 1)_{L0}→(4, 2)_{L0}→(3, 3)_{L0}→(3, 4)_{L0}→(4, 3)_{L0}→(4, 4)_{L0}→(1, 1)_{L1}→(1, 2)_{L1}→(2, 1)_{L1}→(2, 2)_{L1}→(1, 3)_{L1}→(1, 4)_{L1}→(2, 3)_{L1}→(2, 4)_{L1}→(3, 1)_{L1}→(3, 2)_{L1}→(4, 1)_{L1}→(4, 2)_{L1}→(3, 3)_{L1}→(3, 4)_{L1}→(4, 3)_{L1}→(4, 4)_{L1} .

14. The moving picture decoding method according to claim 11, further comprising:
storing motion vector information of neighboring sub-macroblocks, which is used to decode the motion vectors of the first and the second sub-reference blocks, into a motion vector information storage register before decoding of the motion vectors of the first and the second sub-reference blocks; and
storing motion vector information of neighboring sub-macroblocks, which is used to decode the motion vectors of the third and the fourth sub-reference blocks, into the motion vector information storage register before decoding of the motion vectors of the third and the fourth sub-reference blocks.

15. The moving picture decoding method according to claim 14, wherein the block boundary strength of the first sub-macroblock is calculated using the motion vector information of the neighboring sub-macroblocks, which has been stored in the motion vector information storage register to decode the motion vectors of the first and the second sub-reference blocks; and
the block boundary strength of the second sub-macroblock is calculated using the motion vector information of the neighboring sub-macroblocks, which has been stored in the motion vector information storage register to decode the motion vectors of the third and the fourth sub-reference blocks.

16. The moving picture decoding method according to claim 15, wherein the motion vector information storage register stores therein motion vector information of sub-macroblocks respectively located immediately to the left of, immediately above, and immediately to the top right of a sub-macroblock whose motion vector is currently being decoded, the motion vector information including pieces of motion vector information of such three neighboring sub-macroblocks in each of two reference directions used to create a prediction image of a macroblock.

17. The moving picture decoding method according to claim 16, wherein, in decoding a motion vector of a current sub-macroblock, when motion vector information of a sub-macroblock located immediately to the top right thereof has not been decoded, motion vector information of a sub-macroblock located immediately to the top left is stored in the motion vector information storage register instead of the motion vector information of the sub-macroblock located immediately to the top right.

18. The moving picture decoding method according to claim 11, further comprising:
performing motion compensation on a reference frame based on the motion vector information of the sub-reference blocks; and
performing, based on the block boundary strength, deblocking filtering of a decoded image subjected to the motion compensation.

19. A moving picture decoding method, comprising:
decoding a motion vector of a first sub-reference block belonging to a first reference block;
decoding a motion vector of a second sub-reference block belonging to the first reference block and neighboring the first sub-reference block;
decoding a motion vector of a third sub-reference block belonging to a second reference block in a reference direction different from a reference direction of the first reference block;
decoding a motion vector of a fourth sub-reference block belonging to the second reference block and neighboring the third sub-reference block;
calculating a block boundary strength of a first sub-macroblock corresponding to a position of the first and the third sub-reference blocks, after decoding of the motion vectors of the first to the fourth sub-reference blocks; and
calculating a block boundary strength of a second sub-macroblock corresponding to a position of the second and the fourth sub-reference blocks, after decoding of the motion vectors of the first to the fourth sub-reference blocks.

20. The moving picture decoding method according to claim 19, wherein, provided that the macroblock is made up of 16×16 pixels and includes 16 sub-macroblocks of 4×4 pixels and that a position of each of the sub-macroblocks in the macroblock is specified as i row and j column (i=1, 2, 3, 4, j=1, 2, 3, 4), decoding of motion vector information and calculation of a block boundary strength are performed in the following order:
(1, 1)_{L0}→(1, 2)_{L0}→(1, 1)_{L1}→(1, 2)_{L1}→(1, 1)_{bS}→(1, 2)_{bS}→(2, 1)_{L0}→(2, 2)_{L0}→(2, 1)_{L1}→(2, 2)_{L1}→(2, 1)_{bS}→(2, 2)_{bS}→(1, 3)_{L0}→(1, 4)_{L0}→(1, 3)_{L1}→(1, 4)_{L1}→(1, 3)_{bS}→(1, 4)_{bS}→(2, 3)_{L0}→(2, 4)_{L0}→(2, 3)_{L1}→(2, 4)_{L1}→(2, 3)_{bS}→(2, 4)_{bS}→(3, 1)_{L0}→(3, 2)_{L0}→(3, 1)_{L1}→(3, 2)_{L1}→(3, 1)_{bS}→(3, 2)_{bS}→(4, 1)_{L0}→(4, 2)_{L0}→(4, 1)_{L1}→(4, 2)_{L1}→(4, 1)_{bS}→(4, 2)_{bS}→(3, 3)_{L0}→(3, 4)_{L0}→(3, 3)_{L1}→(3, 4)_{L1}→(3, 3)_{bS}→(3, 4)_{bS}→(4, 3)_{L0}→(4, 4)_{L0}→(4, 3)_{L1}→(4, 4)_{L1}→(4, 3)_{bS}→(4, 4)_{bS}, where (i,j)_{L0} is a position of a sub-reference block whose motion vector is to be decoded on the first reference block of the macroblock, (i,j)_{L1} is a position of a sub-reference block whose motion vector is to be decoded on the second reference block, and (i,j)_{bS} is a position of a sub-macroblock whose block boundary strength is to be calculated.
